(19) United States
(12) Patent Application Publication
(10) Pub. No.: US 2006/0185431 A1
(43) Pub. Date: Aug. 24, 2006

(54) Camera motion detection system

(76) Inventors: Henryk Birecki, Palo Alto, CA (US); Robert Walmsley, Palo Alto, CA (US); Peter Hartwell, Sunnyvale, CA (US); Steven Louis Naberhuis, Freemont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/063,509

(22) Filed: Feb. 23, 2005

(51) Int. Cl. G01P 15/00

(52) U.S. Cl. 73/488

(57) ABSTRACT

Provided is a method and system for detecting rotational movement of a camera. Three pairs of accelerometers are located in the camera, with the motion sensing axes of each of the accelerometers in each of the pairs parallel to one another. The accelerometers are relatively positioned in the camera such that the planes formed by the motion sensing axes of each of the pairs of accelerometers are substantially mutually orthogonal.

### FIELD OF THE INVENTION

The present system relates generally to cameras, and in particular, to a method for determining camera motion.

### BACKGROUND

Detection of camera motion is important in order to be able to compensate for image blur due to movement of the camera, and also to allow for image ‘stitching’ when taking multiple pictures to create a continuous scene. Detecting camera rotation is particularly important when an object to be photographed is not close to the camera. Presently known rotation sensors, such as gyroscopic sensors, are expensive, and marginally sensitive to camera rotation. These rotation sensors are typically based on mechanically resonant structures, and each of these sensors must typically operate at different frequencies to minimize crosstalk.

### SUMMARY

A method is provided for detecting rotational movement of a camera.

In one embodiment, one to three pairs of accelerometers are located in the camera. The motion sensing axes of each of the accelerometers in each of the pairs are parallel to one another, and the accelerometers are relatively positioned in the camera such that the planes formed by the motion sensing axes of each of the pairs of accelerometers are substantially mutually orthogonal.

In another embodiment, a differencing device is coupled to an output of each pair of the accelerometers, for generating a difference signal with respect to the outputs of each of the accelerometers in the pair. The difference signal is indicative of the angular acceleration of the camera with respect to the angular sensing direction for each accelerometer pair.

In an additional embodiment, an integrator is coupled to the output of the differencing device, for generating an integrated signal with respect to the output of the differencing device. The integrated signal is indicative of the angular velocity of the camera with respect to the angular sensing direction for each accelerometer pair.

### BRIEF DESCRIPTION OF THE DRAWINGS

FIG. 1 is a diagram showing a perspective view of an exemplary embodiment of the present system which includes a camera with six accelerometers operating in pairs;

FIGS. 2A, 2B, and 2C are side, top, and front views, respectively, of the embodiment shown in FIG. 1;

FIG. 3 is a diagram showing accelerometers A1, A2, B1, B2, C1, and C2 connected to a processor and associated hardware;

FIG. 4 is a flowchart showing an exemplary set of steps performed in operation of one embodiment of the present system; and

FIG. 5 is a diagram of the embodiment of FIG. 1, showing exemplary signal processing functional blocks used to determine rotational motion of camera 101.

### DETAILED DESCRIPTION

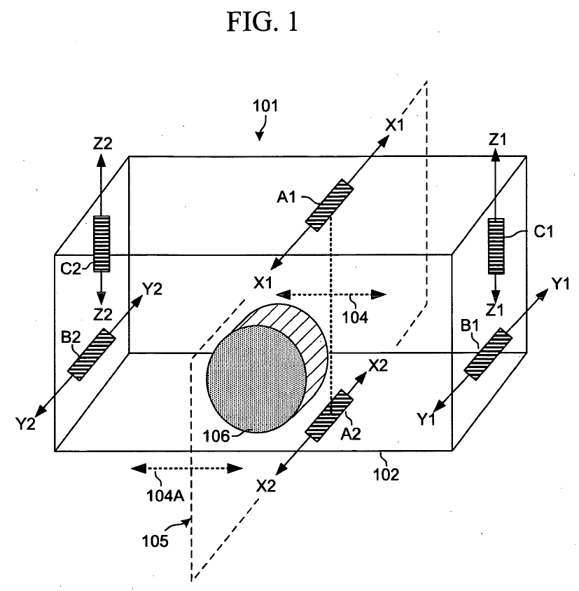

FIG. 1 is a diagram showing a perspective view of an exemplary embodiment of the present system which includes a camera 101 with lens 106 and six accelerometers A1, A2, B1, B2, C1, and C2. These accelerometers function in pairs A1/A2, B1/B2, and C1/C2, in which the two members of each accelerometer pair are spaced apart within the camera body 102. It is to be noted that alternative embodiments of the present system may include fewer than three pairs of accelerometers; therefore, other embodiments may comprise either one or two accelerometer pairs, depending on the functionality required by a particular camera 101.

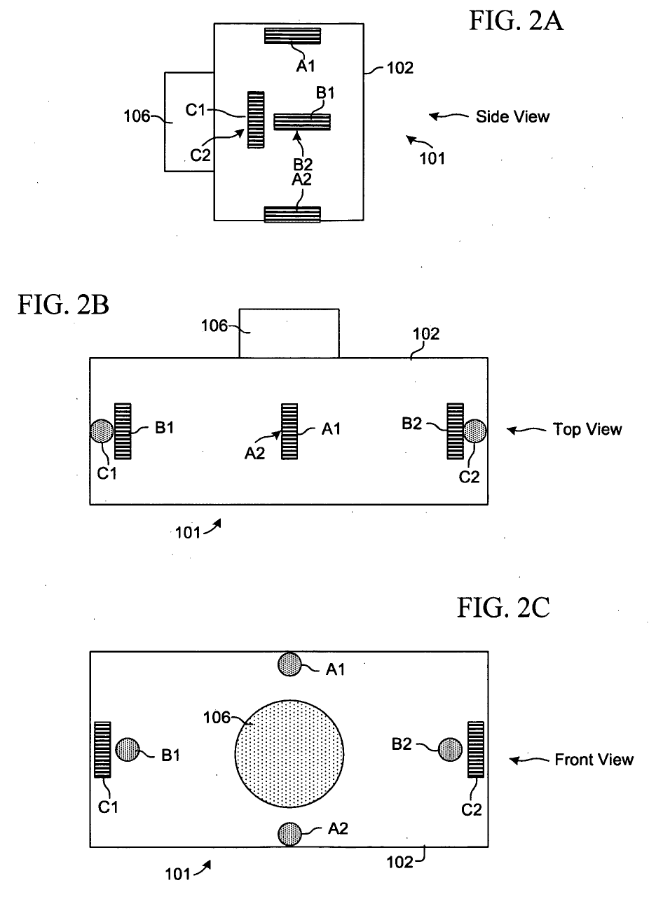

FIGS. 2A, 2B, and 2C are side, top, and front views, respectively, of the embodiment shown in FIG. 1. Three pairs of accelerometers, A1/A2, B1/B2, and C1/C2, are relatively positioned such that the planes formed by the ‘lines of motion’ of the proof mass of each accelerometer pair are substantially mutually orthogonal. The line of motion of the proof mass of an accelerometer is hereinafter referred to as the ‘motion sensing axis’ of the accelerometer.

The accelerometers in each accelerometer pair A1/A2, B1/B2, and C1/C2 are relatively positioned such that the lines of motion (i.e., lines X1/X2, Y1/Y2, and Z1/Z2, for accelerometer pairs A1/A2, B1/B2, and C1/C2, respectively) of the accelerometer proof mass of the accelerometers in each pair are parallel to one another. The motion sensing axis for a given accelerometer is defined herein as an axis along which movement is detected by the accelerometer, which axis is parallel to the line of motion of the accelerometer's proof mass, and which passes through the center of the accelerometer. For example, the motion sensing axis for accelerometer A1 is the line indicated by arrow(s) X1.

The angular acceleration sensing axis for each accelerometer pair is a line that is orthogonal to the plane formed by the lines of motion of accelerometer proof masses of the two accelerometers in a given pair. For example, the angular acceleration sensing axis for accelerometer pair A1/A2 is a line that is orthogonal to plane X1 X2 (indicated by reference no. 105). Although there is only one instantaneous axis of rotation for a given accelerometer pair at any given time, a single accelerometer pair cannot indicate the specific location of that axis. Rather, an accelerometer pair can only determine the direction of rotation of camera 101. Therefore, the term ‘angular sensing direction’ is used herein to describe the direction of rotational motion of camera 101 about an axis (e.g., line 104 or 104A) that is orthogonal to the plane (e.g., plane X1 X2, reference no. 105) formed by the motion sensing axes of the two accelerometers in a given pair.

As shown in FIG. 1, lines 104 and 104A represent two possible axes of rotation of camera 101, both of which have the same angular sensing direction. The angular acceleration with respect to the angular sensing direction for each accelerometer pair is determined by the difference of the signals from two accelerometers in a particular pair and the distance between the lines of motion of the accelerometer proof masses. More specifically, in an exemplary embodiment, angular acceleration as measured by two accelerometers in an accelerometer pair is defined by: (1) the difference of their outputs, (2) the distance between the lines of motion of the accelerometers' proof masses, and (3) the angle that a line joining centers of proof masses of accelerometers makes with the lines of motion of these accelerometers' proof masses (which is a right angle for maximum sensitivity).

As the separation between the two accelerometers in a pair is increased, the rotational sensitivity of the pair is increased, when the present system is employed. In an exemplary embodiment, the accelerometers in each of the accelerometer pairs are positioned as far apart from each other as practicable within the camera body 102, each accelerometer preferably located proximate a different side of the camera body. In an exemplary embodiment, an Analog Devices ADXL203 accelerometer may be used for accelerometers A1, A2, B1, B2, C1, and C2. At 5 centimeters typical separation, a pair of this particular type of accelerometers has a sensitivity of 0.2 radians/secˆ2 with a 50 Hz bandwidth, when employed in accordance with the present method.

It is to be noted that alternative embodiments of the present system may employ a linear acceleration-detecting means other than the above-described type of accelerometer, with the requisite condition that the acceleration-detecting means includes a motion sensing axis having an essentially linear ‘line of motion’. Other alternative embodiments of the present system may include devices other than cameras, in which are located one or more pairs of accelerometers positioned in accordance with the method described herein.

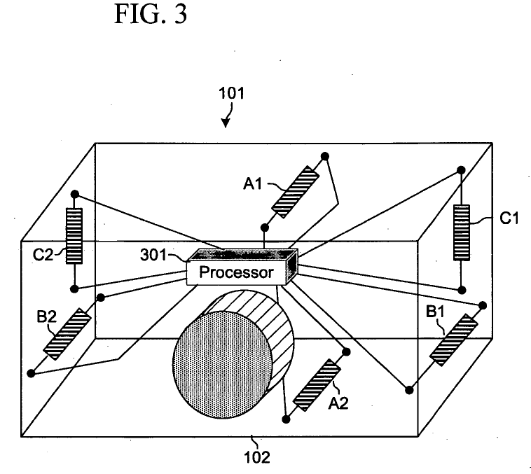

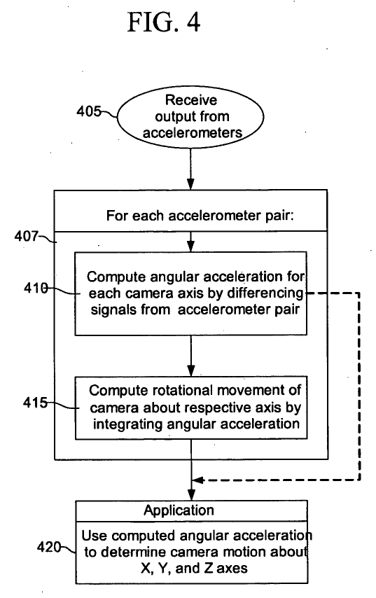

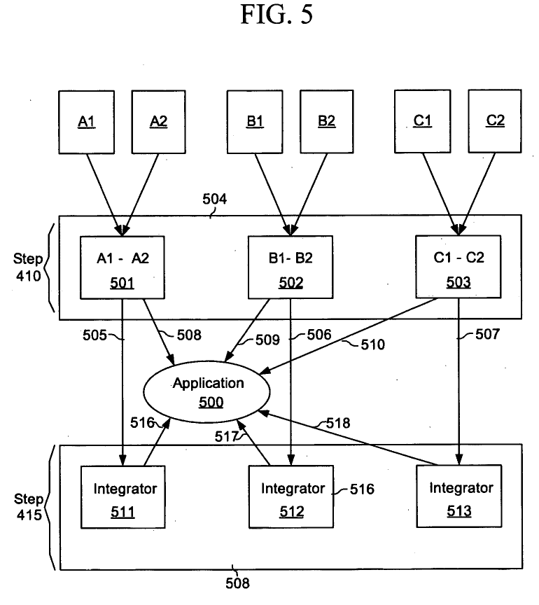

FIG. 3 is a diagram showing accelerometers A1, A2, B1, B2, C1, and C2 connected to processor 301, which may include associated signal processing software and/or hardware. As explained below with respect to FIGS. 4 and 5, signals output by each accelerometer in a particular pair are differenced by processor 301 to provide a value of angular acceleration relative to the angular sensing direction for the accelerometer pair. Optionally, the resulting difference signals may then be integrated (by processor 301) to determine the rotational movement of the camera 101, and further integrated to obtain angular position information.

FIG. 4 is a flowchart showing an exemplary set of steps performed in operation of one embodiment of the present system. FIG. 5 is a diagram of the embodiment of FIG. 1, showing exemplary signal processing functional blocks used to determine rotational motion of camera 101. In one embodiment, each of the functions indicated by blocks 501-503 and 511-513 is performed by processor and associated software and/or hardware 301. Operation of the present system is best understood by viewing FIGS. 4 and 5 in conjunction with one another.

As shown in FIG. 4, at step 405, processor 301 receives the output from accelerometers A1, A2, B1, B2, C1, and C2. The steps in block 407 are then executed for each accelerometer pair A1/A2, B1/B2, and C1/C2. As shown in FIGS. 4 and 5, at step 410, the angular acceleration of camera 101 about a particular angular acceleration sensing axis is determined by differencing the signals output from the respective accelerometer pair.

More specifically, the output signals from accelerometer pair A1/A2 are combined or otherwise processed via differencing function 501 to yield a difference signal (A1−A2) 505. The output signals from accelerometer pairs B1/B2 and C1/C2 are likewise processed via differencing device(s) 301, which perform(s) the signal differencing functions indicated by blocks 502 and 503 to yield difference signals (B1−B2) 506 and (C1−C2) 507, respectively. Each of these difference signals represents a component of the angular acceleration of camera 101 with respect to the corresponding accelerometer pair A1/A2, B1/B2, or C1/C2.

The embodiment shown in FIG. 5 is directed to a simple application 500 for processing small motions (such as image stabilization, as opposed to image stitching) where motions around each axis can be treated independently. For small motion determination, application 500 uses the differenced outputs from accelerometer pairs A1/A2, B1/B2, and C1/C2, together with the integrated outputs from integrators 511-513.

In the present embodiment, at step 415, integrators 511-513 receive difference signals (A1−A2) 505, (B1−B2) 506, and (C1−C2) 507 from differencing device(s) 301. The differenced outputs from accelerometer pairs A1/A2, B1/B2, and C1/C2 are then input to application 500, as indicated by arrows 508, 509, and 510, together with the integrated outputs from integrators 511-513, as respectively indicated by arrows 516, 517, and 518. At step 420, application 500 uses this differenced and integrated information to compute the angular acceleration of camera 101 with respect to the corresponding accelerometer pair A1/A2, B1/B2, or C1/C2, and to thus determine camera motion about the X, Y, and Z axes.

For a more complex application in which motions are too large to be treated independently the differenced outputs from accelerometer pairs A1/A2, B1/B2, and C1/C2 are input directly to application 500, as indicated by arrows 508, 509, and 510. The application then performs the required signal processing, which typically involves double integration of coupled systems of linear equations. In addition, a complex application may also obtain summed signals from each of the accelerometer pairs to obtain positional information in addition to the rotational information.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A system for detecting rotational movement of a camera comprising:
three pairs of accelerometers located in the camera, each of the accelerometers having a motion sensing axis, wherein the motion sensing axes of each of the accelerometers in each of the pairs are parallel to one another, and wherein the accelerometers are relatively positioned in the camera such that the planes formed by the motion sensing axes of each of the pairs of accelerometers are substantially mutually orthogonal.

2. The system of claim 1, including at least one differencing device, coupled to an output of each pair of the accelerometers, for generating a difference signal with respect to the outputs of each pair of the accelerometers, wherein the difference signal is indicative of an angular acceleration of the camera with respect to an angular sensing direction, for each accelerometer pair, about an axis that is orthogonal to the plane formed by the motion sensing axes of the accelerometers in the pair.

3. The system of claim 2, including an integrator, coupled to the output of the differencing device, for generating an integrated signal with respect to the output of the differencing device.

4. The system of claim 1, wherein the outputs from each pair of the accelerometers are differenced to detect motion of the camera in a respective angular sensing direction.

5. The system of claim 1, wherein the accelerometers in each of the pairs are proximate opposite sides of the camera.

6. The system of claim 1, wherein the accelerometers in each of the pairs are positioned at least 1 centimeter from each other.

7. The system of claim 1, wherein the motion sensing axis is an axis along which movement is detected by a particular one of the accelerometers, which axis is parallel to the line of motion of the accelerometer's proof mass, and which passes through the center of the accelerometer.

8. The system of claim 1, wherein exactly two pairs of accelerometers are located in the camera.

9. The system of claim 1, wherein exactly one pair of accelerometers are located in the camera.

10. A system for detecting rotational movement of a camera comprising:
at least one pair of accelerometers located in the camera, each of the accelerometers having a motion sensing axis, wherein the motion sensing axes of the accelerometers are parallel to each other;
wherein the accelerometers are relatively positioned in the camera such that the planes formed by the motion sensing axes of each of the pairs of accelerometers are substantially mutually orthogonal; and
wherein the outputs from each pair of accelerometers are differenced to detect an angular sensing direction about an axis that is orthogonal to the plane formed by the motion sensing axes of the accelerometers in the pair.

11. The system of claim 10, wherein the accelerometers in each pair are proximate opposite sides of the camera.

12. The system of claim 10, wherein the accelerometers in each pair are positioned at least 1 centimeter apart from each other.

13. The system of claim 10, including a differencing device, coupled to outputs from each pair of accelerometers, for generating a difference signal with respect to said outputs.

14. The system of claim 13, including an integrator, coupled to the output of the differencing device, for generating an integrated signal with respect to the output of the differencing device.

15. The system of claim 10, wherein the motion sensing axis is defined as an axis along which movement is detected by a particular one of the accelerometers, which axis is parallel to the line of motion of the accelerometer's proof mass, and which passes through the center of the accelerometer.

16. A method for detecting rotational movement of a camera comprising:
positioning at least one pair of accelerometers in the camera, each of the accelerometers having a motion sensing axis, wherein the motion sensing axes of each of the accelerometers in each said pair are parallel to one another, and wherein the accelerometers are relatively positioned in the camera such that the planes formed by the motion sensing axes of each pair of accelerometers are substantially mutually orthogonal; and
differencing the outputs from each pair of the accelerometers to detect motion of the camera in a respective angular sensing direction that is an axis that is orthogonal to the plane formed by the motion sensing axes of the accelerometers in the pair.

17. The system of claim 16, wherein the motion sensing axis is defined as an axis along which movement is detected by a particular one of the accelerometers, which axis is parallel to the line of motion of the accelerometer's proof mass, and which passes through the center of the accelerometer.

18. The method of claim 16, wherein the accelerometers in each said pair are proximate opposite sides of the camera.

19. The method of claim 16, including a differencing device, coupled to the outputs of each pair of the accelerometers, for generating a difference signal with respect to the outputs of each pair of the accelerometers, wherein the difference signal is indicative of an angular acceleration of the camera with respect to an angular sensing direction, for each accelerometer pair, about an axis that is orthogonal to the plane formed by the motion sensing axes of the accelerometers in each said pair.

20. The method of claim 19, including an integrator, coupled to the output of the differencing device, for generating an integrated signal with respect to the output of the differencing device.

21. A system for detecting rotational movement of a camera comprising:
at least one pair of detecting means for detecting linear acceleration, each detecting means having a motion sensing axis, wherein the motion sensing axes of each of the detecting means in each said pair are parallel to one another, and wherein the detecting means are relatively positioned in the camera such that the planes formed by the motion sensing axes of each pair of the detecting means are substantially mutually orthogonal; and
means for differencing the outputs from each pair of the detecting means to detect motion of the camera in a respective angular sensing direction about an axis that is orthogonal to the plane formed by the motion sensing axes of the detecting means in each said pair.

22. The method of claim 21, wherein the detecting means in each said pair are proximate opposite sides of the camera.

23. The system of claim 21, wherein the motion sensing axis is defined as an axis along which linear movement is detected by a particular one of the detecting means.
